(19) United States
(12) Patent Application Publication
(10) Pub. No.: US 2008/0017634 A1
(43) Pub. Date: Jan. 24, 2008

(54) Method for Inductive Heating of a Workpiece

(75) Inventors: Jan Wiezoreck, Bonn (DE); Carsten Buhrer, Bonn (DE)

Correspondence Address: EDELL, SHAPIRO & FINNAN, LLC, 1901 RESEARCH BOULEVARD, SUITE 400, ROCKVILLE, MD, 20850, US

(73) Assignee: TRITHOR GMBH, Rheinbach (DE)

(21) Appl. No.: 11/767,278

(22) Filed: Jun. 22, 2007

Related U.S. Application Data
(63) Continuation of application No. PCT/EP06/12402, filed on Dec. 21, 2006.

(30) Foreign Application Priority Data
Dec. 22, 2005 (DE) 102005061670.4-37

(51) Int. Cl. H05B 6/22

(52) U.S. Cl. 219/652

(57) ABSTRACT

A method for inductive heating of an electrically conducting workpiece, by rotating the workpiece in a magnetic field of a direct-current carrying coil arrangement comprising superconductive windings about a rotation axis that forms an angle with the principal axis of the magnetic field, allows temperatures that differ from each other along the workpiece to be obtained when the flux density of the magnetic field permeating the workpiece is set differently along the rotation axis.

### CROSS REFERENCE TO RELATED APPLICATIONS

This application is a continuation of International Application No. PCT/EP2006/012402, filed on Dec. 21, 2006, entitled “Method for Inductive Heating of a Workpiece,” which claims priority under 35 U.S.C. §119 to Application No. DE 102005061670.4-37 filed on Dec. 22, 2005, entitled “Method for Inductive Heating of a Workpiece,” the entire contents of which are hereby incorporated by reference.

### BACKGROUND

A method for inductively heating of an electrically conductive workpiece by rotating the workpiece in a magnetic field is known from “Temperature distribution in aluminum billets heated by rotation in a static magnetic field produced by superconducting magnets” (Preprint COMPEL; Vol. 24, No. 1, pages 281 to 290, (2004)). However, the document does not reveal how the method may be put into practice technically.

From WO 2004/066681 A1 it is known to rotate a workpiece in a magnetic field of a direct-current carrying coil arrangement. This makes possible a uniform inductive heating of the workpiece in a static magnetic field. The latter is generated without losses by means of a high-temperature superconducting coil arrangement. The workpiece may be, in particular, a block or billet, for example, of aluminum, copper, or corresponding alloys. Usual diameters are between 50 mm and 400 mm, and usual lengths between 20 mm and 1,000 mm. The rotation axis of the workpiece forms an angle of 90° with the principal axis of the magnetic field. According to the known Law of Induction, the increase of temperature per unit of time becomes greater as the flux density of the magnetic field becomes higher, and as the rotation number of the workpiece becomes higher.

From “Strangpressen”, Aluminium-Verlag Düsseldorf, 2001, 553 to 555, it is known to heat a block inductively so that it has, along an axial direction, a temperature profile which in a subsequent transformation zone leads to an optimum temperature that is the same along the length of the block. With light metals, a block starting-end or block head should therefore have a temperature that is, for example, up to 100° C. higher than that of the block end. With copper alloys, an inverse temperature distribution is frequently desired. For this, the block that is moved linearly through an elongate coil arrangement generating an alternating field is additionally heated following uniform heating to a base temperature by switching on partial coils in desired regions. This method is costly, for reasons of the ohmic losses in the coil arrangement, and the outlay of control technology, amongst others.

From DE 1 215 276 A, a method is known for inductive heating of an electrical workpiece inside an alternating-current fed induction coil which in turn is surrounded by at least one electrical short-circuit ring. By varying the diameter of the short-circuit ring, its reactive or effective power consumption can be regulated in order to achieve a steady, spatially limited variation of the specific heating power of the induction coil.

### SUMMARY

A method is described herein for inductive heating of an electrically conducting workpiece by rotating the workpiece in a magnetic field of a direct-current carrying coil arrangement comprising superconductive windings, about a rotation axis that forms an angle with the principal axis of the magnetic field. The flux density of the magnetic field permeating the workpiece is set differently along the rotation axis. Furthermore, the described method allows temperatures that differ from each other along the workpiece to be obtained when the flux density of the magnetic field permeating the workpiece is set differently along the rotation axis.

The above and still further features and advantages of the present invention will become apparent upon consideration of the following definitions, descriptions and descriptive figures of specific embodiments thereof, wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

Exemplary embodiments of the method and schematically simplified arrangements for its performance are illustrated in the following for example with the aid of the drawings, where:

FIG. 1 is a plan view and a side view of a superconducting race-track coil with a magnetic short-circuit;

FIG. 2 is the same coil, but with an additional coil displaced parallel to the axis;

FIG. 3 is the same coil, but with an additional coil fed with alternating current;

FIG. 4 is the same coil, but with an added yoke enclosing a coil limb;

FIG. 5 is a cross-section through the superconducting coil with a surrounding yoke;

FIG. 6a is another embodiment of a superconducting coil arrangement with a yoke in an end-face view and a partial sectional side view;

FIG. 6b is the same coil arrangement as in FIG. 6a, but with a tilted rotation axis of the workpiece;

FIG. 7a is a superconducting coil on a limb of a C-shaped yoke in an end-face view and a partial sectional view rotated through 90°;

FIG. 7b is an end-face view of a C-shaped yoke with an arrangement of two superconducting coils;

FIG. 8a is a race-track coil similar to FIG. 1, but with a tilted rotation axis of the workpiece;

FIG. 8b is a sectional view of an arrangement of two superconducting coils having a common axis;

FIG. 9 is a race-track coil as in FIG. 1, but with a workpiece that is displaced linearly along its rotation axis within the inner space of the coil;

FIG. 10a is a workpiece with points of temperature measurement;

FIG. 10b is the same workpiece with a rotation axis tilted by 6° with respect to an axis orthogonal to the axis of a magnetic field; and

FIG. 11 is a simplified, but perspective illustration of a cylindrical workpiece, the longitudinal and rotational axis of which is tilted with respect to the plane of a surrounding race-track coil.

### DETAILED DESCRIPTION

Described herein is a method to inductively heat a workpiece such that the temperature of a typical cylindrical workpiece along its central axis coinciding with the rotation axis of the workpiece follows a desired course, i.e., has a temperature gradient that differs from zero, but is not necessarily constant.

The flux density of the magnetic field permeating the workpiece is set differently along the rotation axis. This may be performed either by specifically affecting the local flux density, and/or by suitably positioning the rotating workpiece relative to the inhomogeneous magnetic field.

In the following, for the sake of simplicity the regions of lower flux density are designated as being a (relatively) weaker magnetic field, and conversely, regions of higher flux density as being a (relatively) stronger magnetic field.

The coil arrangement generating the magnetic field is preferably high-temperature superconducting. In particular, it may consist of one or a plurality of dipole magnetic-field generating coils which in the latter case are disposed adjacently to be mechanically parallel, and which enclose an approximately oval space, and which are so-called race-track coils. The workpiece rotates in this space about a rotation axis coinciding approximately with the long axis of the oval.

A flux density that is specifically different along the rotation axis can be generated, for example, via a magnetic short circuit introduced into a partial region of the magnetic field. The magnetic short circuit may consist of a ferromagnetic body. The magnetic field is weaker in the vicinity of this body. The region of the workpiece lying within this magnetic field is accordingly heated less intensely.

The flux density that is different along the rotation axis may also be generated via an additional coil.

This additional coil may be positioned, for example, to be displaced parallel to the axis of the superconducting coil arrangement. The additional coil may be positioned, for example, to be laterally adjacent to the coil arrangement on a level with one or the other end of the oval space, in order to amplify the magnetic field which is already stronger in this region. The part of the rotating workpiece located within this region is then heated more intensely.

Optionally, the additional coil can be positioned on the same axis as the rotation axis to surround the workpiece concentrically in a partial region of the magnetic field. The workpiece is then permeated by both the magnetic field of the coil arrangement, and also the magnetic field, orthogonal to this, of the additional coil that in this case is fed with alternating current.

A flux density that differs in dependence upon locality may be generated also via a ferromagnetic yoke surrounding the coil arrangement on the outside. It is possible to affect the strength of the magnetic field along the rotation axis by appropriately configuring the geometry of the yoke along the straight long coil sides. At the same time, the yoke has the advantage of screening-off the magnetic field of the coil arrangement to the outside, and of increasing the flux density within the space enclosed by the coil arrangement and therewith through the coil arrangement at the same number of ampere turns.

To further increase the flux density, the yoke can be optionally configured in a shape similar to a torus that is open on the inside.

Alternatively, the yoke also may have a closed or an open, circular or C-shaped cross-section with at least one pole-piece on each of both sides of the rotation axis. In the case of an open cross-section (at right angles to the rotation axis), or more exactly, of a hollow cylinder that is open along a surface line, the rotation axis of the workpiece is located between the faces of the hollow cylinder that define the slot-shaped opening and form the pole-pieces, or are configured to be pole-pieces.

Basically, the coil arrangement may be seated at any desired place on the yoke. The magnetic field, however, may be generated also via one superconducting coil on each one of the pole-pieces.

The flux density that differs along the rotation axis may be optionally generated via changing a spacing of the pole-faces of the pole-pieces of the yoke along the rotation axis.

A flux density of the magnetic field permeating the workpiece, which differs along the rotation axis, can be set in particular also by changing the angle between the rotation axis of the workpiece and the principal axis of the magnetic field. This angle then deviates from 90°. The point about which the rotation axis is tilted from the principal axis of the magnetic field can be chosen in dependence upon the temperature distribution required along the length of the workpiece. If the rotation axis is tilted, for example, around a point located in the region of an end-face of a cylindrical workpiece, then, this region of the workpiece remains in the region of the strong magnetic field, while the opposite end-face region is located in a weaker magnetic field and is therefore heated less intensely. The angle of tilt may be between about 2° and about 20°, in accordance with an angle between about 88° and 70° formed by the rotation axis and the principal axis of the magnetic field.

In the following paragraphs, exemplary embodiments of the method are described in connection with the figures.

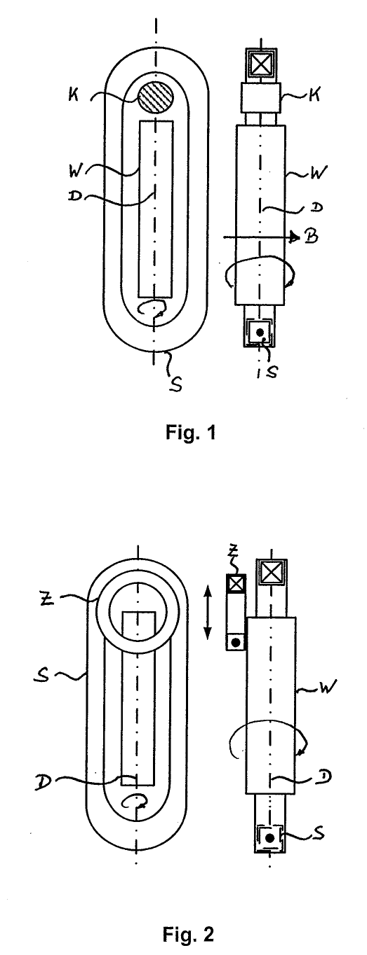

FIG. 1 shows a schematically simplified superconducting race-track coil S. It comprises a number of windings (not shown) and carries a direct current, so that it generates a dipole magnetic field. This permeates a cylindrical workpiece W of an electrically conducting material. The workpiece may be, for example, an aluminum bar or billet. The workpiece W is driven to be rotated about its longitudinal axis D. The drive is not illustrated. As is known, the workpiece W becomes inductively heated in this manner. In order to produce a temperature gradient along the workpiece, a magnetic short-circuit K is located in the upper part of the oval space, here in the form of a short cylinder of a ferromagnetic material. The magnetic field B permeating the workpiece W is weakened in the vicinity of the short-circuit K. The upper-end region of the workpiece W is therefore subjected to less heating than those regions of the workpiece which are permeated by the unweakened magnetic field of the coil S.

FIG. 2 shows an arrangement which in principle is the same as that of FIG. 1, however, an additional coil Z is disposed to be displaced axially parallel to the coil S, the windings of which also carry a direct current. With same direction of windings of the additional coil Z and the coil S, the magnetic fields are superimposed to increase the total magnetic field permeating the upper part of the workpiece W. This part of the workpiece W is therefore heated more intensely than the remaining part. If another region of the workpiece W is to be heated more intensely than the remaining regions, then the additional coil Z is shifted in the direction of the double arrow to the desired place. The desired temperature difference or excess increase of temperature may be set by changing the exciting current of the additional coil Z.

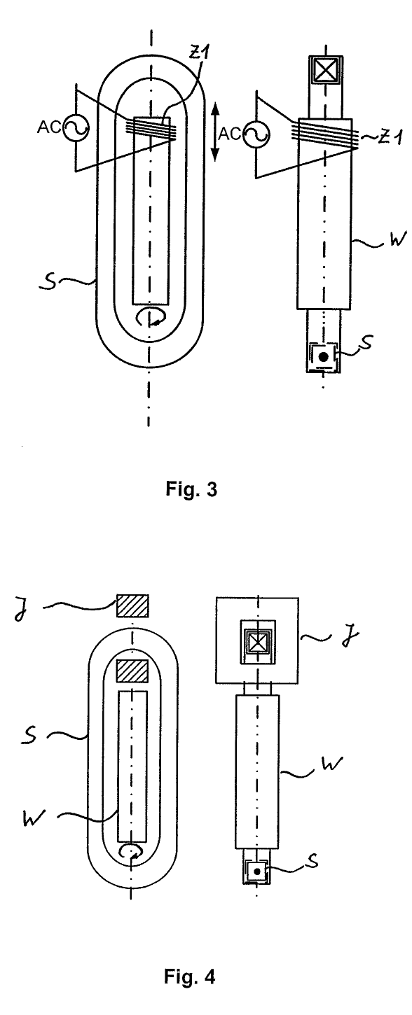

According to FIG. 3, the same effect is achieved with an alternating-current fed additional coil Z1 which is disposed in the space enclosed by the coil S to surround the workpiece W concentrically, and also to be displaceable along the double arrow.

Instead of providing, as in FIG. 1, merely a magnetic short-circuit in the space enclosed by the coil S, according to FIG. 4 a closed yoke J can be disposed around the upper short limb of the coil S. The yoke J improves the magnetic short-circuit and simultaneously screens off the magnetic field of the coil S at this place towards the outside. Accordingly, in this embodiment too the upper region of the workpiece W is heated less than the remaining region.

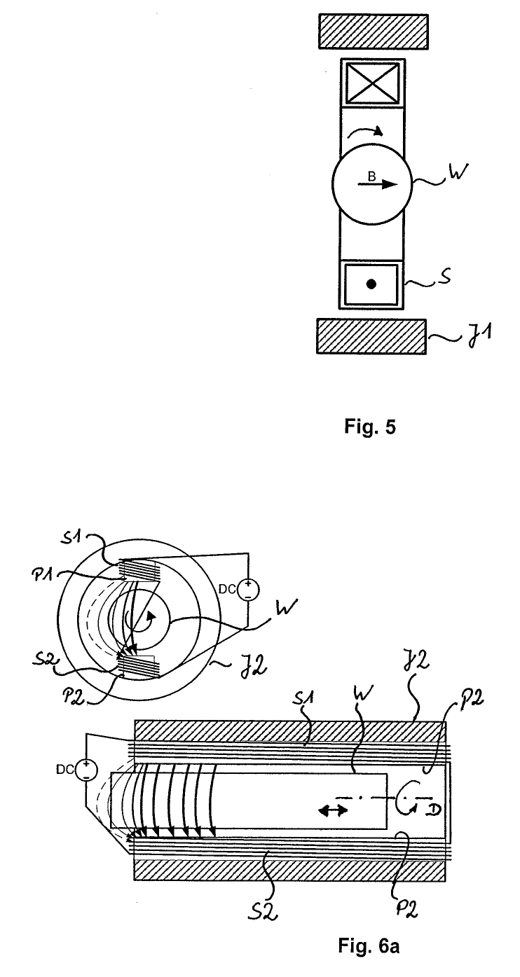

A modification of this embodiment is illustrated by FIG. 5. A yoke J1 encloses the entire coil arrangement and thereby substantially screens-off the magnetic field totally towards the outside. At the same time, the excitation power needed to generate the magnetic filed with the flux direction B, or in other words, the excitation current through the coil S, is reduced. Differences of heating of the workpiece W, i.e., a temperature gradient along its axis, may be achieved with this arrangement also via the measures illustrated with the aid of the FIGS. 1 to 3.

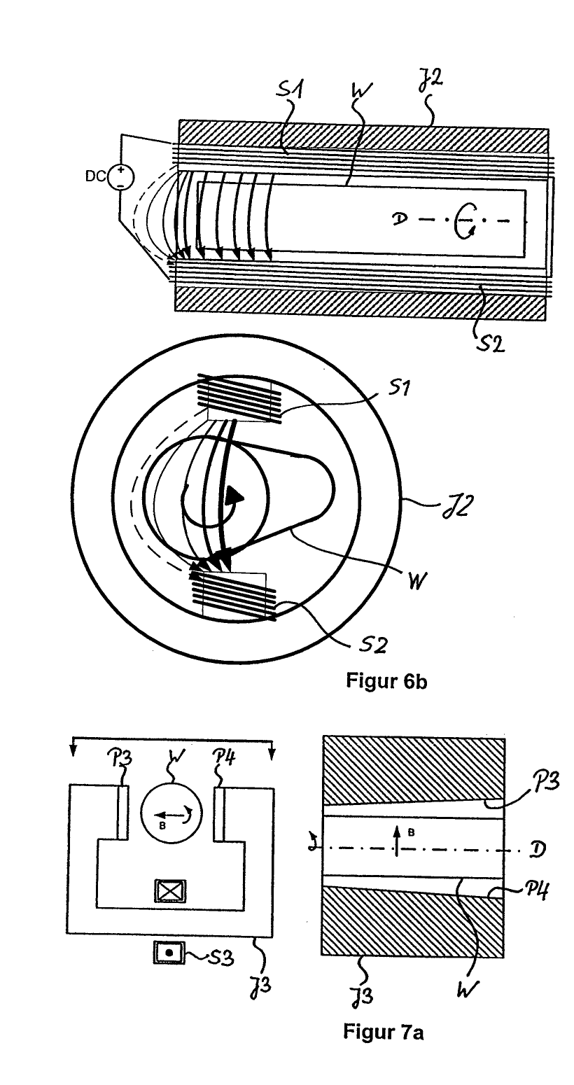

The arrangement illustrated in FIG. 6a starts out from a closed yoke J2 with pole-pieces P1 and P2 which each bear a superconducting coil S1 and S2, respectively, and which are electrically connected in series and carry a direct current. The different strengths of the magnetic field are denoted by the line widths of the arrows symbolizing the field lines. As is evident from the side view, displacing the workpiece W to a greater or lesser extent along its rotation axis D makes is possible to achieve that one end of the workpiece W rotates in a stray field which becomes progressively weaker outside the yoke J2, and accordingly becomes heated less than the remaining region of the workpiece W.

FIG. 6b shows an arrangement similar to that of FIG. 6a, however, in this case the workpiece W is variably heated not by displacing it along the rotation axis D, but by tilting this rotation axis with respect to the long axis of the coil arrangement S1, S2, J. This is indicated by the semi-perspective illustration of the cylindrical workpiece W in the end-face view of FIG. 6b.

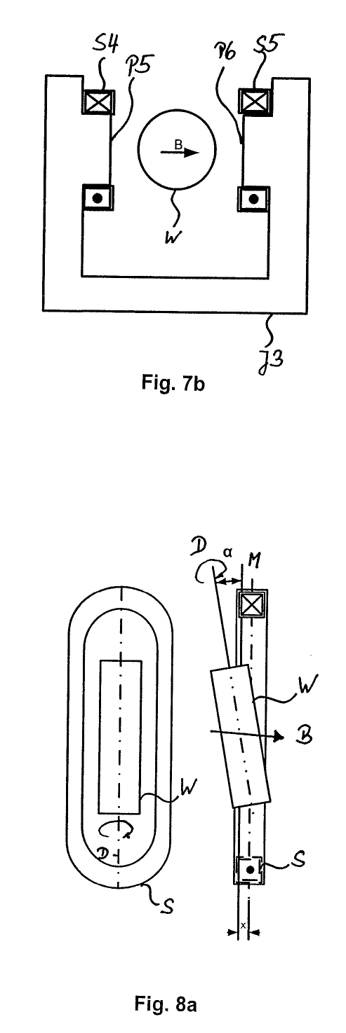

FIG. 7a shows an arrangement in which a superconducting coil S3 encloses the long limb of a C-shaped yoke J3, between the pole-pieces P3 and P4 of which the workpiece rotates. The sectional view and the rotated plan view clearly show that the pole pieces P3 and P4 define a space around the workpiece W, which narrows from the right-hand side to the left-hand side, so that the workpiece W becomes heated progressively more intensely along its extent from its right-hand side to its left-hand side, in accordance with the decrease of the air-gap. This arrangement has the advantage of an approximately constant temperature gradient along the length of the workpiece.

The arrangement of FIG. 7b operates according to the same principle with the only difference that here, instead of one coil, two superconducting coils S4 and S5 are employed, each of which surrounds a pole-piece P5 and P6, respectively.

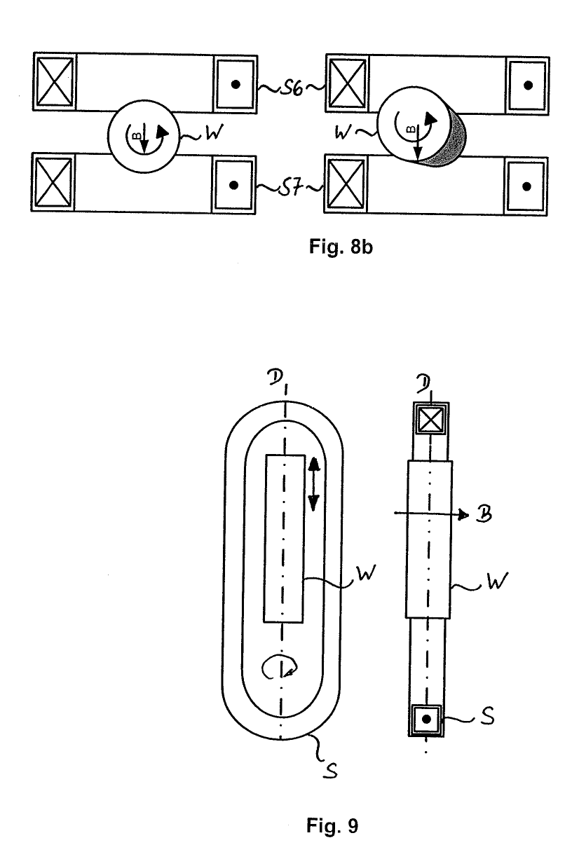

The arrangement illustrated in FIG. 8a operates with a race-track coil S in analogy with FIG. 1, however, differences of heating of the workpiece W along its rotation axis D are achieved by this rotation axis being tilted with respect to the center plane of the coil S through an angle α about a point lying on the center axis M. Consequently, the flux density B decreases from the lower to the upper end of the workpiece W, so that the upper end of the workpiece becomes heated less intensely than its remaining region.

The arrangement of FIG. 8b operates according to the same principle, however, with two superconducting coils S6 and S7 disposed on a common axis adjacently or in series, whereby a higher flux density B is achieved.

FIG. 9 also shows a race-track coil S enclosing the workpiece W. However, the workpiece is displaced upwards along the rotation axis D from its symmetrical position within the space enclosed by the coil S. As a consequence of this, the upper part of the workpiece W is located in a region of higher flux density B than the remaining region of the workpiece, and is therefore more intensely heated. In addition, and in analogy with the arrangement in FIG. 8a, the workpiece can be tilted, if desired, out of the center plane of the coil S about a point that is then expediently located in the region of the upper end-face (not illustrated).

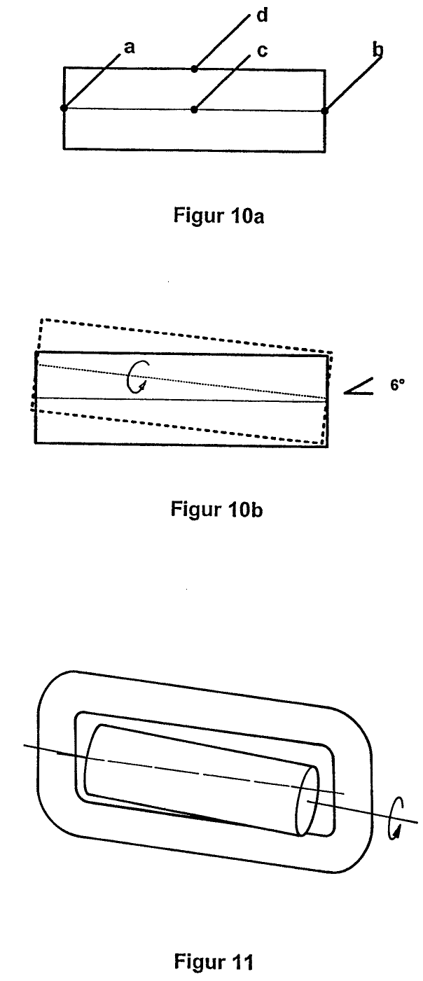

The following table illustrates on a numerical example the attainable temperatures and temperature differences. The workpiece consists of a billet having a length of 800 mm and a diameter of 250 mm. In the table, the term “Equilibrium” denotes a waiting time following the end of the inductive heating and prior to a determination of the temperatures at the points as drawn in FIG. 10a. The angle of tilt α in the first column is defined as in FIGS. 8a and 10b. The linear displacement in the second column refers to the displacement of the workpiece along the rotation axis D as explained with the aid of FIG. 9. Particularly the entries in the last five lines show that it can be of advantage to apply both of the basically separately applicable measures of a displacement of the workpiece and a tilting of its rotation axis also in combination with each other.

| | Linear | | Rota- | | | | | |
|---|---|---|---|---|---|---|---|---|
| | displace- | Coil | tion | | | | | |
| Billet | ment from | Inside | num- | Equil- | Temperature | | | |
| α | center | length | ber | ibrium | a | b | c | d |
| [°] | [mm] | [mm] | [Hz] | [s] | [° C.] | [° C.] | [° C.] | [° C.] |
| 0 | 0 | 1500 | 4 | 50 | 350 | 350 | 380 | 405 |
| 2 | 0 | 1500 | 4 | 50 | 355 | 360 | 385 | 420 |
| 3 | 0 | 1500 | 4 | 50 | 360 | 350 | 385 | 415 |
| 5 | 0 | 1500 | 4 | 50 | 350 | 305 | 360 | 393 |
| 6 | 0 | 1500 | 4 | 50 | 350 | 280 | 340 | 366 |
| 10 | 0 | 1500 | 4 | 50 | 312 | 200 | 255 | 284 |
| 6 | 0 | 1500 | 4 | 50 | 350 | 280 | 340 | 366 |
| 6 | 0 | 1500 | 5 | 50 | 445 | 360 | 420 | 460 |
| 6 | 0 | 1500 | 6 | 50 | 550 | 435 | 500 | 550 |
| 6 | 0 | 1500 | 5 | 150 | 460 | 375 | 430 | 440 |
| 6 | 0 | 1500 | 6 | 150 | 545 | 445 | 495 | 505 |
| 0 | 0 | 1500 | 5 | 150 | 470 | 470 | 475 | 490 |
| 0 | 0 | 1500 | 5 | 150 | 470 | 470 | 475 | 490 |
| 6 | 0 | 1500 | 5 | 150 | 470 | 375 | 430 | 440 |
| 6 | −50 | 1500 | 5 | 150 | 480 | 370 | 430 | 445 |
| 6 | −100 | 1500 | 5 | 150 | 490 | 370 | 440 | 440 |
| 6 | −200 | 1500 | 5 | 150 | 535 | 370 | 450 | 450 |

FIG. 11 illustrates in perspective, but schematically simplified, a billet with a tilted rotation axis in a race-track coil.

While the invention has been described in detail with reference to specific embodiments thereof, it will be apparent to one of ordinary skill in the art that various changes and modifications can be made therein without departing from the spirit and scope thereof. Accordingly, it is intended that the present invention covers the modifications and variations of this invention provided they come within the scope of the appended claims and their equivalents.

What is claimed is:

1. A method to inductively heat an electrically conducting workpiece, the method comprising:
providing a magnetic field of a direct-current carrying coil arrangement including superconductive windings and a magnetic short-circuit disposed in a partial region of the magnetic field; and
rotating the workpiece in the magnetic field about a rotation axis that forms an angle with a principal axis of the magnetic field and in which a flux density of the magnetic field permeating the workpiece along the rotation axis is set differently;
wherein the flux density that is different along the rotation axis is generated via the magnetic short-circuit.

2. A method to inductively heat an electrically conducting workpiece, the method comprising:
providing a magnetic field of a direct-current carrying coil arrangement comprising superconductive windings and an additional coil; and
rotating the workpiece in the magnetic field about a rotation axis that forms an angle with the principal axis of the magnetic field and in which a flux density of the magnetic field permeating the workpiece along the rotation axis is set differently;
wherein the flux density that is different along the rotation axis is generated via the additional coil.

3. The method according to claim 2, wherein the additional coil is arranged parallel to the axis of the superconducting coil arrangement.

4. The method according to claim 2, wherein the additional coil surrounds the workpiece concentrically in a partial region of the magnetic field and is arranged on the same axis as the rotation axis.

5. A method to inductively heat an electrically conducting workpiece, the method comprising:
providing a magnetic field of a direct-current carrying coil arrangement comprising superconductive windings and a ferromagnetic yoke surrounding the outside of the coil arrangement; and
rotating the workpiece in the magnetic field about a rotation axis that forms an angle with the principal axis of the magnetic field and in which a flux density of the magnetic field permeating the workpiece along the rotation axis is set differently;
wherein the different flux density along the rotation axis is generated via the ferromagnetic yoke.

6. The method according to claim 5, wherein the yoke is configured similarly to a torus that is open on the inside.

7. The method according to claim 5, wherein the yoke includes at least one pole-piece disposed on each of both sides of the rotation axis, the yoke having a cross-section shape selected from the group including: an open circular shape, a closed circular shape or a C-shape.

8. The method according to claim 7, wherein the superconducting windings, of the coil arrangement that generates the magnetic field, are disposed on each one of the pole-pieces.

9. The method according to claim 7, wherein the different flux density along the rotation axis is generated via changing a spacing of pole-faces of the pole-pieces along the rotation axis.

10. A method to inductively heat an electrically conducting workpiece, the method comprising:
providing a magnetic field of a direct-current carrying coil arrangement comprising superconductive windings; and
rotating the workpiece in the magnetic field about a rotation axis that forms an angle with the principal axis of the magnetic field and in which a flux density of the magnetic field permeating the workpiece along the rotation axis is set differently;
wherein the different flux density along the rotation axis is set via changing the angle formed by the rotation axis and the principal axis of the magnetic field.

11. The method according to claim 10, wherein the angle formed by the rotation axis and the principal axis of the magnetic field is set to a value between about 70° and about 88°.
